(19) United States
(12) Patent Application Publication
(10) Pub. No.: US 2009/0168415 A1
(43) Pub. Date: Jul. 2, 2009

(54) METHOD AND SYSTEM FOR ADJUSTING THE LIGHT SETTING FOR A MULTI-COLOR LIGHT SOURCE

(75) Inventors: Peter Hubertus Franciscus Deurenberg, Eindhoven (NL); Eugen De Mol, Eindhoven (NL); Geert Willem Van Der Veen, Eindhoven (NL); Johannes Trudo Cornelis Van Kemenade, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/719,882

(22) PCT Filed: Nov. 24, 2005
(86) PCT No.: PCT/IB05/53896

§ 371 Date: May 22, 2007

(30) Foreign Application Priority Data
Nov. 29, 2004 (EP) 04106126.8

(51) Int. Cl. F21S 10/02

(52) U.S. Cl. 362/233

(57) ABSTRACT

The present inventions relates to a method for adjusting the light setting for a multi-color light source, which method comprises receiving input from a user related to at least one of white color, hue, and chroma, and adjusting white color, hue, and chroma of the light source in accordance with the user input. The method is characterized in the step of automatically changing a current hue and chroma level when the user input is received. This automatic change makes possible to render the subsequent adjustment in setting perceivable for the user, which facilitates the adjustment of the light source. The present invention also relates to a corresponding system and computer program product.

The present inventions relates to a method for adjusting the light setting for a multi-color light source, which method comprises receiving input from a user related to at least one of white color, hue, and chroma, and adjusting white color, hue, and chroma of the light source in accordance with the user input. The present invention also relates to a corresponding system and computer program product.

A method for adjusting the light settings for a multi-color light source is disclosed in the document “Hue & chroma colour setting method” published at IP.COM under number IPCOM 00029468D. The document discloses a method comprising three steps for adjusting the light settings. First, the wanted white color is selected The white color is selected from the black radiation curve or the black body locus (BBL), from warm white to cold white. The BBL is a line of points in a chromaticity diagram (e.g. the CIE chromaticity diagram) corresponding to colors emitted from a black body at different temperatures. Then, the wanted color or hue is selected This is the color that is added to the chosen white color. The selected color can be regarded as a selected angle of a vector starting from the selected white color point on the BBL. Finally, in the third step the wanted chroma is selected. This is the saturation or amount of the color already chosen. The chroma is determined by the length of the vector in the CIE chromaticity diagram. Thus, a user can adjust the light settings of a multi-color light source with the aid of three different control means/inputs: 1) white color, 2) hue (color), and 3) chroma (saturation).

However, the method disclosed in IPCOM 00029468D has some drawbacks. For example, when on the black body locus with zero color saturation (no vector length), the color setting is “disabled” or “inactive”, i.e. there will be no change in output of the multi-color light source when the color is adjusted. Thus, when zero saturation is selected it is not possible to see the selected color. Further, when at full saturation, the white color setting is “inactive”, i.e. adjusting the white color will have no effect on the output of the multi-color light source. Indeed, above certain saturation, adjustment of the white color will not result in a perceivable different color. Also, adjustment of the saturation when no color is selected will result in erroneous operation, since there is no color selected for which saturation can be adjusted. These possible illogical commands make the setting and adjustment of the color of the light source less obvious for the user.

It is an object of the present invention to provide an improved method for adjusting the light setting for a multi-color light source, which facilitates the setting or adjustment of the light source color output for the user.

This and other objects that will be evident from the following description are achieved by means of a method, and a corresponding system, according to the appended claims.

According to an aspect of the invention, there is provided a method by way of introduction, further comprising automatically changing a current hue and chroma level when the user input is received.

The invention is based on the understanding that by automatically changing a current hue and chroma level when the user input is received, i.e. when one of white color, hue, and chroma is to be set, it is possible to render the subsequent adjustment in setting perceivable for the user, which facilitates the adjustment of the light source. The light source will always react in a similar way when an illogical command is given, which also facilitates the adjustment of the light source.

In one embodiment of the invention, the method further comprises the step(s) of determining whether the current setting is perceivably on the black body locus (BBL), i.e. if the current setting of white color, hue, and chroma results in light output that corresponds to a position along the black body locus (BBL) of for example the CIE chromaticity diagram, and, if this is the case, automatically setting a predetermined hue and chroma level off the BBL when user input related to one of hue and chroma is received.

A setting “perceivably” on the BBL should be construed as meaning that the color setting is either on the BBL, or close enough to the BBL so that there is no perceivable color difference in output from the light source for the human eye compared to a position actually on the BBL.

This conditional jump to a predetermined hue and chroma level, i.e. a certain color and saturation, when either hue or chroma is to be adjusted makes it possible for the user to clearly see the subsequent adjustment in hue or chroma. Thus, there are no “invisible” changes, such as if color is adjusted when no saturation is selected, as discussed above in the background. Instead the user will clearly see what color is added. Also, due to the conditional jump to a certain hue and chroma level, the illogical command of adjusting saturation when no color is selected is avoided. It should be noted that if the current setting is perceivably off the BBL, the adjustment of hue or chroma will be executed as normal without the jump to the predetermined hue and chroma level.

Preferably, the step of automatically setting a predetermined hue and chroma level is performed only if the current color setting has been perceivably on the BBL for a predetermined time. In this way, a default jump to the predetermined hue and chroma level, when a user adjusts the settings so that the setting “accidentally” crosses the BBL, is avoided.

Also, preferably, the above mentioned predetermined hue and chroma level corresponds to a moderate green color. Green color is advantageous since blue and yellow can be added by moving along the BBL (in context of the CIE chromaticity diagram). Alternatively, purple color can for example be used.

In another embodiment of the invention, the method further comprises the step(s) of determining whether the current setting is perceivably on the black body locus (BBL), and, if this is not the case, automatically shifting the setting to the BBL when user input related to white color is received.

This conditional jump to the BBL when white color is to be adjusted makes it possible for a user to clearly see the effect of the subsequent white color adjustment. As discussed above in the background, if white color is adjusted when a certain level of saturation is set, the change will not be perceivable for the user. Preferably, the default jump involves jumping to a certain predetermined position on the BBL, i.e. setting a predetermined color temperature, for example 4000 Kelvin. It should be noted that if the current setting already is perceivably on the BBL, the adjustment of white color will be executed without any jump to the BBL.

According to another aspect of the invention there is provided a system for adjusting the light setting for a multi-color light source, which system comprises means for receiving input from a user related to at least one of white color, hue, and chroma, means for adjusting white color, hue, and chroma of the light source in accordance with the user input, and means for automatically changing a current hue and chroma level when the user input is received. This system offers similar advantages as obtained with the previously discussed aspect of the invention.

These and other aspects of the present invention will be described in more detail in the following, with reference to the appended figures showing presently preferred embodiments.

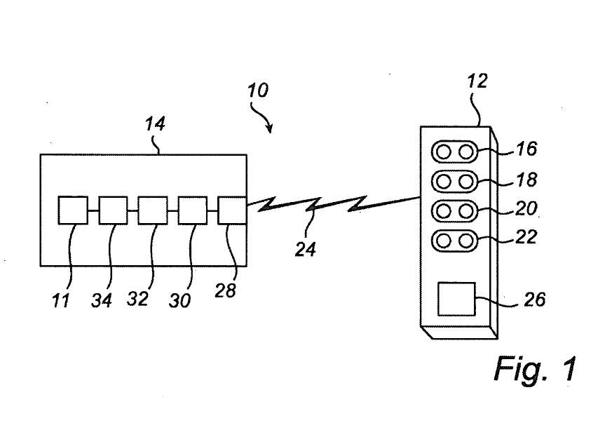

FIG. 1 is a schematic view of a system for adjusting the light setting for a multi-color light source according to one embodiment of the invention,

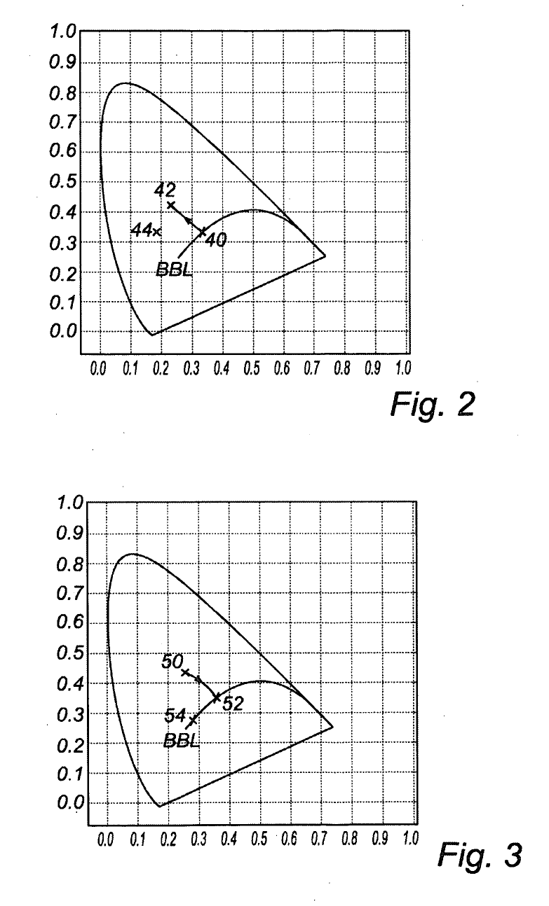

FIG. 2 shows a default jump to a predetermined hue and chroma level according to one embodiment of the invention in the context of the CIE chromaticity diagram,

FIG. 3 shows a default jump to the BBL according to one embodiment of the invention in the context of the CIE chromaticity diagram, and

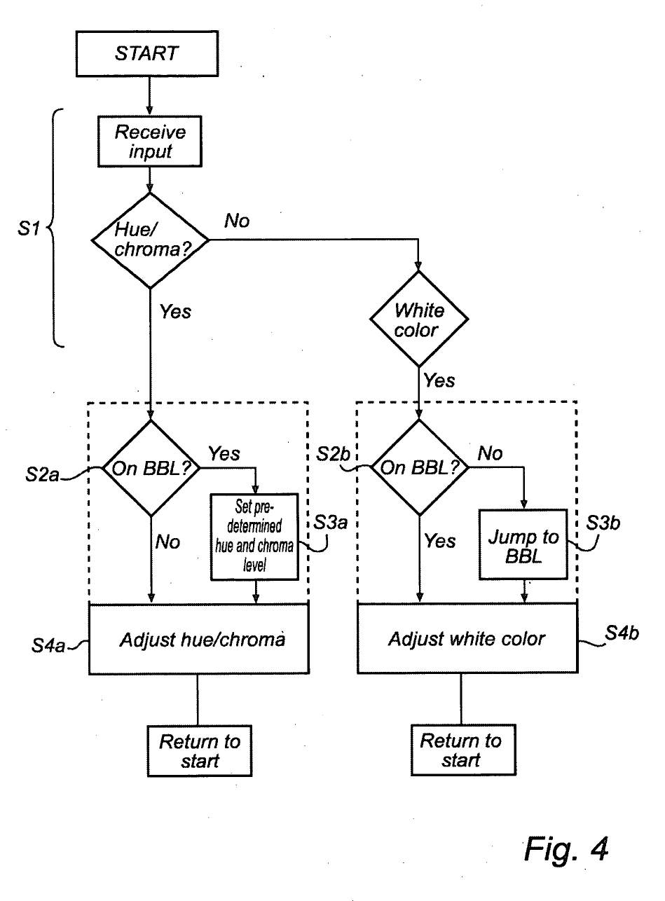

FIG. 4 is a flow chart of a method for adjusting the light setting for a multi-color light source according to one embodiment of the invention.

FIG. 1 shows a system 10 for adjusting the light setting for a multi-color light source 11 according to one embodiment of the invention. The system 10 comprises a first device, here a remote control 12, and a second device 14, which comprises means 28 for receiving user input instructions via the remote control 12 and means 34 for adjusting white color, hue, and chroma of the output of the multi-color light source 11 based on the received user input.

The remote control 12 is equipped with means for input of user instructions. In FIG. 1, the user input means is constituted by a plurality of two-toggle knobs 16, 18, 20, 22 corresponding to dim-level, white color, hue (color), and chroma (saturation), respectively. Thus, actuating a certain knob results in a decrease/increase or change of the setting in question. The remote control 12 is in communication with the second device 14, preferably via a wireless link 24, such as IR. The remote control 12 can further be equipped with means 26 for storing and/or retrieving of certain color settings, i.e. certain combinations of white color, hue, and chroma. These setting can be default preset settings and/or settings manually stored by the user.

In the context of the CIE chromaticity diagram, the basic operation of the system 10 is similar to the method disclosed in IPCOM 00029468D discussed above. Thus, adjustment of white color corresponds to a movement along the black body locus (BBL), the selected color can be regarded as the angle of a vector starting from the selected white color point on the BBL, and the saturation or amount of color is determined by the length of the vector.

According to the invention, the second device 14 further comprises means 30 for determining whether the current color setting is perceivably on the BBL, and means 32 for automatically setting a certain color setting when user input is received. The means 30, 32, and 34 can for example be implemented in the driver and software of the light source.

The method as well as the operation of the system according to the invention will now be described in relation to FIGS. 2-4. When a user is about to adjust the hue or chroma setting, i.e. when he or she initially actuates either of the hue knobs 20 or the chroma knobs 22, it is first determined (step S1, FIG. 4) that it is hue or chroma that is selected, after which the determining means 30 determines (step S2a) whether the current color setting of the light source corresponds to a position perceivably on the black body locus (BBL). If this is the case, a predetermined hue and chroma level is automatically set (step S3a). Thus, there is a jump from a setting on the BBL to a predetermined setting off the BBL. This is illustrated in FIG. 2 as a movement or jump from a position 40 on the BBL to a position 42 off the BBL. Then, if the user again actuates the hue or chroma knobs, there will be an adjustment of the hue or chroma starting from the setting corresponding to position 42 off the BBL (step S4a). Thus, when on the BBL (no color and/or saturation) and a color knob 20 is selected, there will be an output of a predetermined color at a predetermined saturation to allow the user to clearly see what will happen if the color knob is actuated again, i.e. what color that is selected. Also, when on the BBL and a saturation knob 22 is selected, there will be a predetermined output of a more saturated color to allow the user to clearly see what will happen if the saturation knob is actuated again, i.e. what saturation that is set. Preferably, the predetermined position 42 corresponds to a moderate green color.

If the determining means 30 determines that the current setting corresponds to a position already perceivably off the BBL, such as position 44, subsequent activation of the hue or chroma knobs will result in normal adjustment of hue or chroma level without any preceding automatic jump to the predetermined setting (position 42).

It should be noted that the automatic default jump is preferably only made if the chosen color setting has been on the (perceivable) BBL for a certain time (for example 1 minute). As a result, a default jump to the predetermined hue and chroma level, when a user adjusts the settings so that the setting “accidentally” crosses the BBL, is avoided.

Determining whether the current setting is perceivably on the BBL can for example be performed by determining the current color coordinates of the light source based on the chosen hue and chroma level, and calculate the difference between these coordinates and the known coordinates of the trajectory of the BBL. If the difference is smaller than a predetermined threshold, the current setting is perceivably on the BBL.

Further, when a user is about to adjust the white color setting, i.e. when he or she initially actuates any of the white color knobs 18, it is first determined that it is white color that is selected (step S1), after which the determining means 30 as above determines (step S2b) whether the current color setting is perceivably on the BBL. If this is not the case, the setting is automatically shifted to the BBL (step S3b). Thus, there is a jump from a setting off the BBL to a setting on the BBL. Preferably, the setting is shifted to a certain predetermined position on the BBL. This is illustrated in FIG. 3 as a movement from a position 50 off the BBL to a position 52 on the BBL. Then, if the user again actuates the white color knobs, there will be an adjustment of the white color starting from the setting corresponding to position 52 on the BBL (step S4b). The adjustment of the white color corresponds to a movement along the BBL. Thus, when off the BBL and a white color knob 18 is selected, there will be an output corresponding to a position on the BBL to allow the user to clearly see what will happen if the white color knob is actuated again, i.e. what color temperature that is set. Preferably, the predetermined position 52 corresponds to a color temperature of about 4000 K.

If the determining means 30 determines that the current setting corresponds to a position already perceivably on the BBL, such as position 54, subsequent activation of the white color knobs will result in normal adjustment of the white color without any preceding automatic jump to a setting on the BBL (such as position 52).

Preferably, in order to enable fast adjustment of the color of the light source, the means 16, 18, 20, 22 for input of user instructions of the remote control are so adapted that the activation of certain knob for a prolonged time results in an increased rate of change for the setting at issue. For example, when actuating the white color knob 16 in order to increase the color temperature, initially the rate of change is slow. However, by keeping the knob depressed for a prolonged time, the rate of increase of color temperature is accelerated. An example of an acceleration scheme can be found in table 1 below. The acceleration scheme is applicable to all toggle knobs 16, 18, 20, 22 of the remote control 12.

| | | |
|---|---|---|
| Press style | Press time | Relative step size |

| | | | |
|---|---|---|---|
| Single press | <500 | ms | 1 |

| | | |
|---|---|---|
| Long press | 500 ms-5 s | 2 |

| | | |
|---|---|---|
| 5-10 | s | 4 |
| >10 | s | 10 |

The invention is not limited to the embodiments described above. Those skilled in the art will recognize that variations and modifications can be made without departing from the scope of the invention as claimed in the accompanying claims. For example the first device can be incorporate in the second device, or vice versa.

Also, the method and system according to the present invention is applicable to all multi-color light sources that are user adjustable, such as LEDs, fluorescent light sources, etc.

Further, the light source 11 can alternatively be external of the second device 14 shown in FIG. 1.

1. A method for adjusting the light setting for a multi-color light source comprising:
receiving input from a user related to at least one of white color, hue, and chroma, adjusting white color, hue, and chroma of said light source in accordance with said user input,
characterized in that it further comprises:
automatically changing a current hue and chroma level when said user input is received.

2. A method according to claim 1, further comprising:
determining whether the current setting is perceivably on the black body locus (BBL), and, if this is the case,
automatically setting a predetermined hue and chroma level off the BBL when user input related to one of hue and chroma is received.

3. A method according to claim 2, wherein the step of automatically setting a predetermined hue and chroma level is performed only if the current color setting has been perceivably on the black body locus (BBL) for a predetermined time.

4. A method according to claim 1, further comprising:
determining whether the current setting is perceivably on the black body locus (BBL), and, if this is not the case,
automatically shifting the setting to the BBL when user input related to white color is received.

5. A method according to claim 4, wherein the setting is shifted to a predetermined position on the black body locus (BBL).

6. A system (10) for adjusting the light setting for a multi-color light source, comprising:
means (18, 20, 22) for receiving input from a user related to at least one of white color, hue, and chroma,
means (34) for adjusting white color, hue, and chroma of said light source in accordance with said user input, and
means (30, 32) for automatically changing a current hue and chroma level when said user input is received.

7. A system according to claim 6, further comprising:
means (30) for determining whether the current setting is perceivably on the black body locus (BBL), and, if this is the case,
means (32) for automatically setting a predetermined hue and chroma level off the BBL when user input related to one of hue and chroma is received.

8. A system according to claim 6, further comprising:
means (30) for determining whether the current setting is perceivably on the black body locus (BBL), and, if this is not the case,
means (32) for automatically shifting the setting to the BBL when user input related to white color is received.

9. A system according to claim 8, wherein the setting is shifted to a predetermined position on the black body locus (BBL).

10. A system according to claim 6, wherein said means (18, 20, 22) are incorporated in a first device (12), and wherein said means (30, 32, 34) are incorporated in a second device (14), said second device being in communication with said first device.

11. A system according to claim 10, wherein said first device is a remote control (12).

12. A system according to claim 6, wherein activation by the user of said input means (18, 20, 22) for a predetermined time causes accelerated adjustment of white color, hue, and chroma, respectively, by the means (34).

13. A computer program product, comprising computer program code for performing the method according to claim 1.

14. A computer readable medium, having computer program code embodied therein for performing the method according to claim 1.
